(19) United States
(12) Patent Application Publication
(10) Pub. No.: US 2017/0213416 A1
(43) Pub. Date: Jul. 27, 2017

(54) Gaming Machine with Symbol Replacement

(71) Applicant: Pridefield Limited, Douglas (GB)

(72) Inventor: Jonathan Wortmann, Buderim (AU)

(21) Appl. No.: 15/392,946

(22) Filed: Dec. 28, 2016

(30) Foreign Application Priority Data
Jan. 25, 2016 (GB) 1601306.2

(51) Int. Cl. G07F 17/32; G07F 17/34

(52) U.S. Cl. CPC G07F 17/3213; G07F 17/3225; G07F 17/3244; G07F 17/34

(57) ABSTRACT

A first set of symbols associated with respective positions of reels may be selected as an outcome event of a reel-based game. The first set of symbols may include one or more trigger symbols. It may be determined that (i) the outcome event does not include a primary trigger event that causes execution of a bonus feature, and/or (ii) the outcome event includes a secondary trigger event that causes replacement of the one or more trigger symbols. Possibly in response to determining that the outcome event includes the secondary trigger event, the one or more trigger symbols may be replaced with replacement symbols to form a second set of symbols. A bonus payout amount associated with the second set of symbols may be determined. An indication of the bonus payout amount may be provided to the client machine.

### CROSS-REFERENCE TO RELATED APPLICATION

This application claims priority to U.K. Intellectual Property Office (UKIPO) patent application no. 1601306.2, filed Jan. 25, 2016, which is hereby incorporated by reference in its entirety.

### BACKGROUND

Wager games come in a variety of forms, including for example a mechanical slot machine. A mechanical slot machine may include one or more reels, each of which includes a fixed pattern of symbols distributed around the circumference of the reel. When a player places a wager (e.g., by placing a coin in the machine), the player is allowed to spin the reels. Each reel then comes to rest, typically with either one of the symbols, or a space in between symbols, in alignment with a pay line. A predefined winning symbol or a predefined combination of winning symbols that are aligned with the pay line can result in the player winning the game and receiving a payout. In one example, the machine may include three reels, and the pay line may be a horizontal line disposed across a centre of each of the three reels.

In another example of a wager game, a mechanical slot machine may present symbols in a matrix arrangement, with each symbol changing during a spin of the game according to the fixed pattern of symbols on the reels. For example, the machine may have five columns and three rows of symbols, for a total of fifteen symbols. Such machines often have multiple pay lines, each being defined by a collection of positions within the matrix. For example, the machine may have three pay lines, each corresponding to one row of the matrix.

### SUMMARY

While slot machines were traditionally mechanical, modern slot machines often take the form of a video gaming machine (e.g., a dedicated gaming machine located in a casino) that includes a graphical user interface (GUI), and that may emulate a mechanical slot machine. With a video gaming machine, the GUI may display an image of one or more reels or a matrix as described above, together with animation effects to simulate a spin of the one or more reels, or a spin of the columns or rows of the matrix. A computer software program, which may reside in the video gaming machine, may randomly select one or more symbols in response to a spin, and may display the selected one or more symbols on the display.

A modern slot machine may also be played over a computer network, such as by a player using a client machine that is connected to a server machine over the computer network. In this instance, the server machine may perform the spins of the game and may send the resulting symbols to the client machine for display.

The popularity of video slot games has increased due to the incorporation of novel features, such as a “Scatter” symbol, into such games. These features may assist in making winning results and provide a player with entertainment and additional opportunities to win games.

Unlike predefined winning symbols or predefined combinations of symbols that must be aligned with a pay line in order for the player to win the game and receive a payout, Scatter symbols need not appear on a pay line in order for the player to receive a payout or for additional game features to be unlocked.

In a 5-reel video slot game, three or more Scatter symbols may be required to trigger a bonus game feature. A player may be awarded a consolation payout for a “near miss”, i.e., when only two Scatter symbols appear on the reels or on the display. In some cases, instead of this “near miss” payout, the Scatter symbols may be replaced by Wild symbols, and these Wild symbols may enhance any payout associated with the displayed symbols.

Viewed from a first aspect, the disclosure provides a computer-implemented method for symbol replacement in a reel-based game, where the reel-based game may be executed on behalf of a client machine. The reel-based game may involve spinning a plurality of reels to determine outcome events, and a memory may store respective pluralities of symbols for the reels. Accordingly, a first set of symbols associated with respective positions of each of the reels may be selected as an outcome event of the reel-based game. The first set of symbols may include one or more trigger symbols. The first set of symbols may be stored in the memory. It may be determined that (i) the outcome event does not include a primary trigger event that causes execution of a bonus feature, and/or (ii) the outcome event includes a secondary trigger event that causes replacement of the one or more trigger symbols. Possibly in response to determining that the outcome event includes the secondary trigger event, the one or more trigger symbols may be replaced with replacement symbols to form a second set of symbols. The second set of symbols may be stored in the memory. A bonus payout amount associated with the second set of symbols may be determined. An indication of the bonus payout amount may be provided to the client machine.

Viewed from a second aspect, the disclosure provides an article of manufacture including a non-transitory computer-readable medium, having stored thereon program instructions that, upon execution by a gaming machine, cause the gaming machine to perform the operations of the first aspect.

Viewed from a third aspect, the disclosure provides a gaming machine configured to perform the operations of the first aspect.

Viewed from a fourth aspect, the disclosure provides a system comprising means for performing the operations of the first aspect.

Viewed from a fifth aspect, the disclosure provides a gaming system that comprises a plurality of gaming devices each including at least one display device and a plurality of input devices including: (i) an acceptor of a physical item associated with a monetary value, (ii) a validator configured to identify the physical item, and (iii) a cash-out button actuatable to cause an initiation of a payout associated with a credit account; one or more gaming device processors; and one or more gaming device memory devices storing (i) respective pluralities of symbols for the reels and (ii) a plurality of gaming device instructions. The gaming device instructions may be executable by the one or more gaming device processors to perform the operations of the first aspect.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a simplified block diagram of a machine, in accordance with example embodiments.

FIG. 2 is a simplified block diagram of an example server machine connected to an example client machine over a computer network, in accordance with example embodiments.

FIG. 3A is a first part of a flow chart, in accordance with example embodiments.

FIG. 3B is a second part of the flow chart of FIG. 3A, in accordance with example embodiments.

FIG. 4 depicts diagrams of tables that may be used with the processes, machines, and systems herein, in accordance with example embodiments.

FIG. 5 depicts elements displayable by a display of a machine, in accordance with example embodiments.

FIG. 6 depicts an example of a selected symbol set in a display, in accordance with example embodiments.

FIG. 7 depicts an example of another selected symbol set in a display, in accordance with example embodiments.

FIG. 8 depicts an example of the symbol set of FIG. 7 that includes a number of replacement symbols, in accordance with example embodiments.

FIG. 9A is a first part of a flow chart, in accordance with example embodiments.

FIG. 9B is a second part of the flow chart of FIG. 9A, in accordance with example embodiments.

FIG. 10A is a first part of a flow chart, in accordance with example embodiments.

FIG. 10B is a second part of the flow chart of FIG. 10A, in accordance with example embodiments.

FIG. 11 is a flow chart, in accordance with example embodiments.

### DETAILED DESCRIPTION

### I. Introduction

This description describes several example embodiments including, but not limited to, example embodiments pertaining to performing aspects of an outcome event using a machine. Performing the outcome event can include playing a game. The machine can display a variety of symbols during performance of an outcome event. A symbol displayed within a symbol-display portion of a display during an outcome event may be replaced by another symbol. The replacement symbols can be used to determine a payout amount for an outcome event in which a wager is won.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Disclosed herein are machines and methods for carrying out aspects of outcome events that include displaying symbols, such as games, in particular, wager games. In one aspect, the machines and methods provide a feature that may enhance traditional wager games (e.g., slot machines or other reel-type games) by providing a player with additional opportunities to win the game, thereby increasing the player's interest, anticipation, and excitement in connection with the game. This may in turn benefit a casino or another entity that provides a game with this feature. Indeed, wager games are typically configured to have odds that favour the casino (sometimes referred to as the “house”). Accordingly, based on the law of averages, casinos often maximize their profits simply by getting more players to play more games. Due to the provided feature, players may be drawn in (e.g., from competing casinos that lack games with such a feature) and they may play the game often. The feature can include new data communications between a server machine and a client machine within a server-client based configuration.

### II. Example Architecture

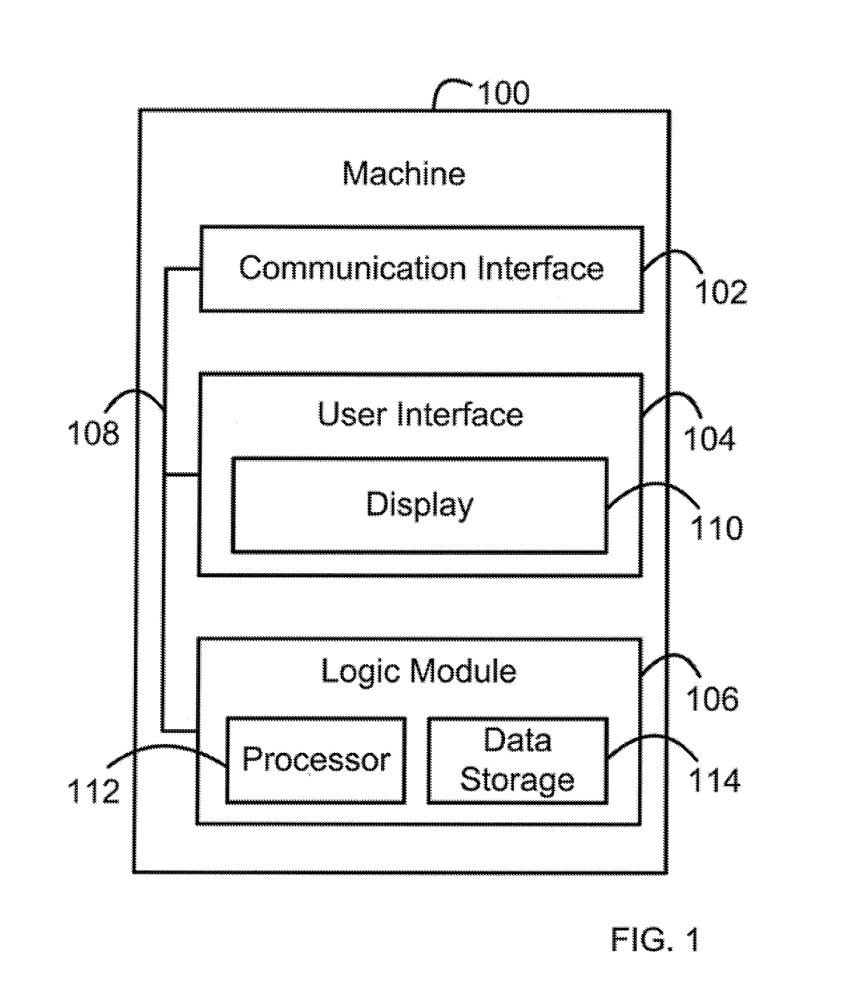

FIG. 1 shows a simplified block diagram of an example machine 100 arranged to implement operations in accordance with example methods described herein. Machine 100 may take any of a variety of forms, including for example a dedicated gaming machine, a personal computer, a server computer, a personal digital assistant, a mobile phone, a tablet device, or some other computing device.

Machine 100 may include a communication interface 102, a user interface 104, and a logic module 106, all of which may be coupled together by a system bus, network, or other connection mechanism 108. The communication interface 102 may include a wired or wireless network communication interface. For purposes of this description, any data described as being provided, sent, or transmitted by machine 100 can be data sent by communication interface 102 over a communication network. Also, for purposes of this description, any data described as being received by machine 100 can be data sent to communication interface 102 over a communication network.

The user interface 104 may facilitate interaction with a user (e.g., a player of a game) if applicable. As such, the user interface 104 may take the form of a GUI and may include output components such as a speaker and a display 110, and input components such as a keypad or a touch-sensitive screen. As described in greater detail below, display 110 may be configured to display, among other things, a symbol set in a game or a portion thereof.

The logic module 106 can take the form of a processor 112 and a data storage 114. The processor 112 can include a general-purpose processor (e.g., a microprocessor) or a special-purpose processor (e.g., a digital signal processor or an application specific integrated circuit) and may be integrated in whole or in part with the communication interface 102 or the user interface 104. Any processor discussed in this description or shown in the drawings can be referred to as a computer-readable processor. Any data storage discussed in this description or shown in the drawings can be referred to as computer-readable data storage.

Data storage 114 may include volatile or non-volatile storage components and may be integrated in whole or in part with processor 112. Data storage 114 may take the form of a non-transitory computer-readable medium and may include software program instructions, that when executed by processor 112, cause machine 100 to perform one or more of the operations described herein. Any software program instructions discussed in this description or shown in the drawings can be referred to as computer-readable program instructions, or more simply, program instructions.

Data storage 114 may also include operating system software on which machine 100 may operate. For example, machine 100 may operate on a Windows®-based operating system (e.g., Windows 7 or Windows 10) provided by the Microsoft® Corporation of Redmond, Wash. Other examples of operating systems are possible.

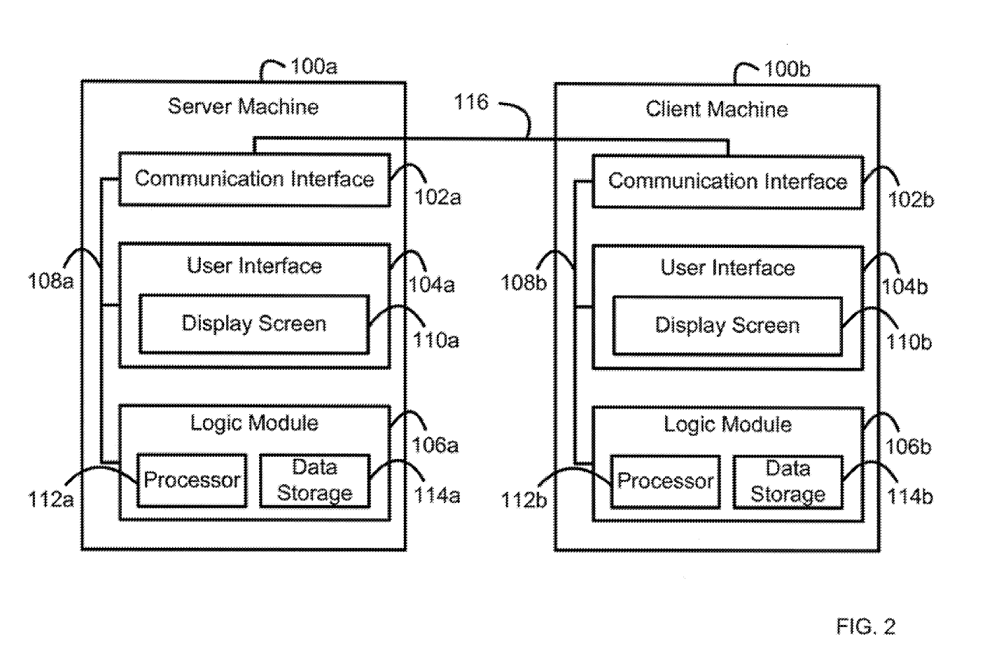

FIG. 2 is a simplified block diagram of an example server machine 100a connected to an example client machine (sometimes referred to as a workstation) 100b over a computer-network 116. A configuration of elements including server machine 100a and client machine 100b can be referred to as a server-client based configuration.

The components of the server machine 100a and the client machine 100b are shown with corresponding “a” and “”b” reference numerals (i.e., based on machine 100). Server machine 100a includes communication interface 102a, user interface 104a (which incorporates display screen 110a), logic module 106a (which incorporates processor 112a and data storage 114a), and communication bus 108a. Likewise, client machine 100b includes communication interface 102b, user interface 104b (which incorporates display screen 110b), logic module 106b (which incorporates processor 112b and data storage 114b), and communication bus 108b.

The server machine 100a is configured to communicate with the client machine 100b over the computer-network 116 (via the communication interfaces 102a, 102b). Likewise, the client machine 100b is configured to communicate with the server machine 100a over the computer-network 116. For purposes of this description, any data described as being sent or transmitted by the server machine 100a can be data sent by communication interface 102a over communication network 116. Similarly, any data described as being sent or transmitted by the client machine 100b can be data sent by communication interface 102b over communication network 116. Furthermore, for purposes of this description, any data described as being received by the server machine 100a can be data the server machine 100a receives from the communication network 116 using communication interface 102a. Similarly, any data described as being received by the client machine 100b can be data the client machine 100b receives from the communication network 116 using communication interface 102b.

The computer-network 116 for the server-client based configuration described above may take a variety of forms. For example, the computer-network 116 may be a local area network (LAN) in a casino, such that client machines 100b dispersed throughout the casino may communicate with the server machine 100a in the casino.

In another example, the computer-network 116 may be a wide-area network (WAN), such as an Internet network or a network of the World Wide Web. In such a configuration, the client machine 100b may communicate with the server machine 100a via a website portal (for a virtual casino) hosted on the server machine 100a. The data described herein as being transmitted by server machine 100a to client machine 100b or by client machine 100b to server machine 100a can be transmitted as datagrams according to the user datagram protocol (UDP), the transmission control protocol (TCP), or another protocol.

The computer-network 116 may include any of a variety of network topologies and network devices, and may employ traditional network-related technologies, including for example the public switched telephone network, cable networks, cellular wireless networks, WiFi, and WiMAX. Further, the computer-network 116 may include one or more databases (e.g., a player credit account database), to allow for the storing and retrieving of data related to performing an outcome event by a machine, as well as adjusting account balances associated with client machines.

For purposes of this description, any operation listed in a sentence including the words the “machine 100 can cause,” the “server machine 100a can cause,” or the “client machine 100b can cause” can be carried out, at least in part, as a result of that particular machine executing software program instructions. Those software program instructions can be stored within data storage 114, 114a, or 114b.

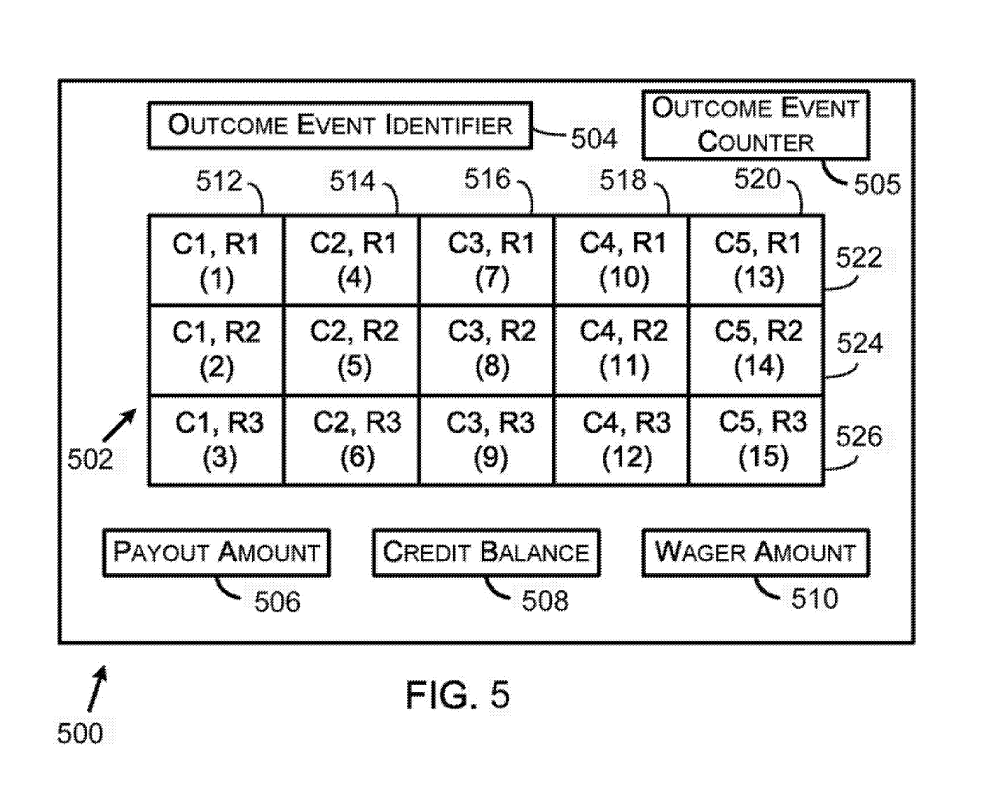

Next, FIG. 5 depicts a screenshot 500 that machine 100, server machine 100a, or client machine 100b can visually present (i.e., display) using displays 110, 110a, and 110b, respectively. For purposes of this description, each element of screenshot 500 can be a displayable element of the display. Screenshot 500 includes a symbol-display-portion 502, an outcome event identifier 504, an outcome event counter 505, a payout amount indicator 506, a credit balance indicator 508, and a wager amount indicator 510.

Symbol-display-portion 502 can include multiple symbol-display-segments and multiple symbol positions. As an example, the symbol-display-segments can include vertical symbol-display-segments 512, 514, 516, 518, and 520 (or more simply, vertical SDS 512-520). As another example, the symbol-display-segments can include horizontal symbol-display-segments 522, 524, and 526 (or more simply, horizontal SDS 522-526). Each symbol-display-segment can include multiple symbol positions. The vertical SDS 512-520 are shown in FIG. 5 as having three symbol positions. The horizontal SDS 522-526 are shown in FIG. 5 as having five symbol positions. A person skilled in the art will understand that those symbol-display-segments can be configured with different numbers of symbol positions than shown in FIG. 5.

The vertical SDS 512-520 can be configured as spinnable reels. The processor of a machine or system displaying screenshot 500 can display the spinnable reels spinning and stopped after spinning. For vertical SDS 512-520, the spinnable reels may spin in a vertical direction (e.g., top to bottom or bottom to top, with respect to the symbol-display-portion 502).

The horizontal SDS 522-526 can be configured as spinnable reels. The processor of a machine or system displaying screenshot 500 can display the spinnable reels spinning and stopped after spinning. For horizontal SDS 522-526, the spinnable reels may spin in a horizontal direction (e.g., left to right or right to left, with respect to the symbol-display-portion 502).

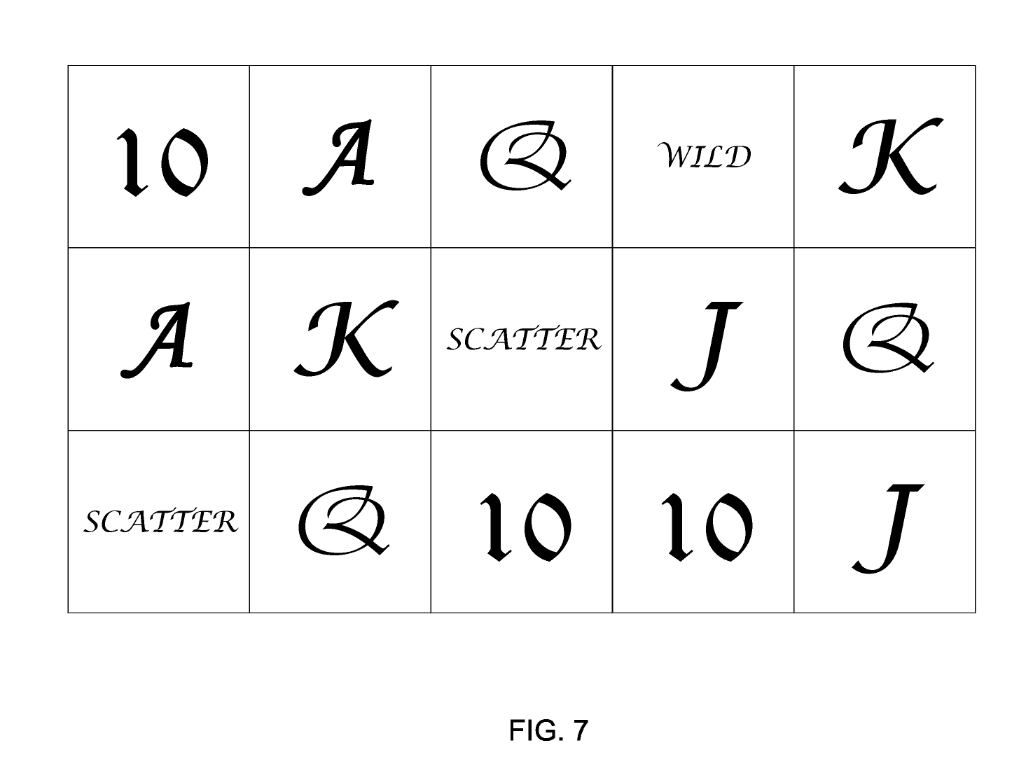

The multiple symbol positions in symbol-display-portion 502 are identified by column and row designators, in which C1=column 1, C2=column 2, C3=column 3, C4=column 4, C5=column 5, R1=row 1, R2=row 2, and R3=row 3. The multiple symbol positions in symbol-display-portion 502 are also identified by distinct numerical identifiers shown within parenthesis. C1 can be a first SDS. C2 can be a second SDS. C3 can be a third SDS. C4 can be a fourth SDS. C5 can be a fifth SDS. As shown in FIG. 7, C2 is between C1 and C3, C3 is between C2 and C4, and C4 is between C3 and C5.

For a matrix arrangement with 15 symbol positions as shown in FIG. 5, the numerical identifiers can be whole numbers 1 through 15, inclusive. The processors or machines described herein can be configured to select a symbol position of symbol-display-portion 502 using a random number generator that is configured to generate a number within the range 1 through N, inclusive, where N equals the number of symbol positions in symbol-display-portion 502. For the matrix arrangement, each symbol-display segment can be a distinct column of the multiple columns within the matrix. Alternatively, for the matrix arrangement, each symbol-display segment can be a distinct row of the multiple rows within the matrix.

The processor of the machines or systems described herein can determine a state the machine or system is operating in or an outcome event that can occur during the determined state of the machine or system. In response to making that determination, the processor can cause the outcome event identifier 504 to display an identifier of the outcome event that can occur during the determined state. For example, the outcome event identifier can identify a base outcome event, a bonus outcome event or another type of outcome event. The bonus outcome event can be a “free spins” outcome event or some other outcome event.

The processor of the machines or systems described herein can determine a wager amount placed on an outcome event, a payout amount after or during occurrence of an outcome event resulting in a win, a credit balance after or while decreasing a number of credits based on placement of a wager or after or while increasing a number of credits based on a determined payout amount, and a number of awarded remaining outcome events that can occur. The processor can cause the determined wager amount to be displayed by the wager amount indicator 510, the determined payout amount to be displayed by the payout amount indicator 506, the determined credit balance to be displayed by the credit balance indicator 508, and the number of awarded remaining outcome events to be displayed by the outcome event counter 505.

### III. Example Operations

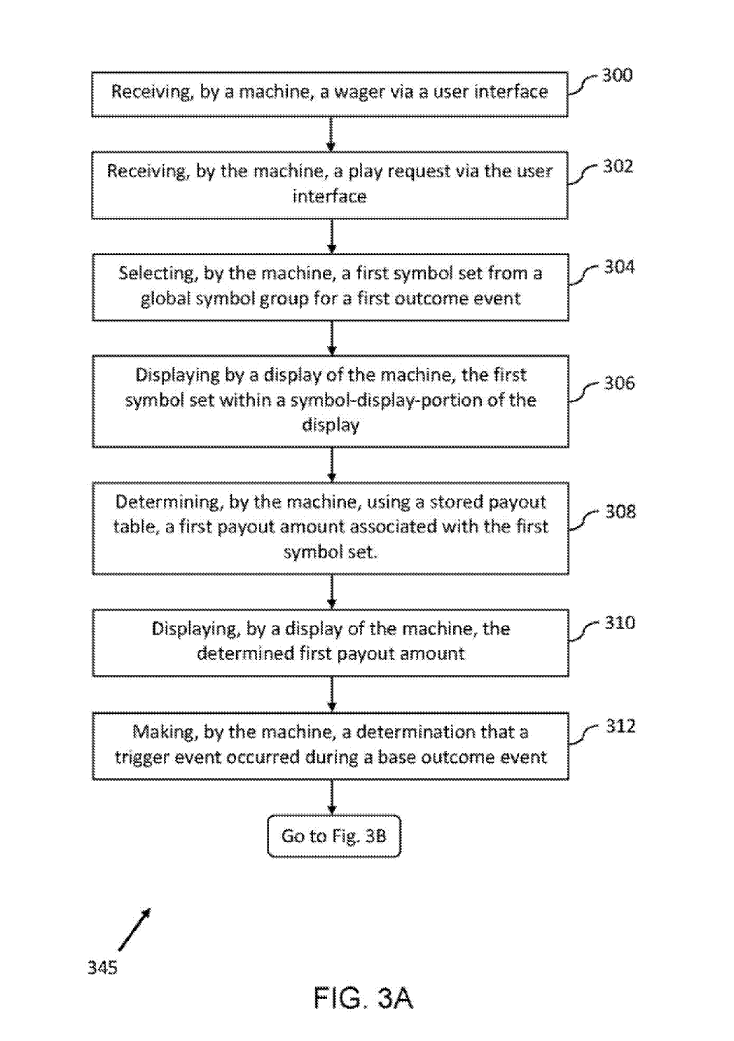

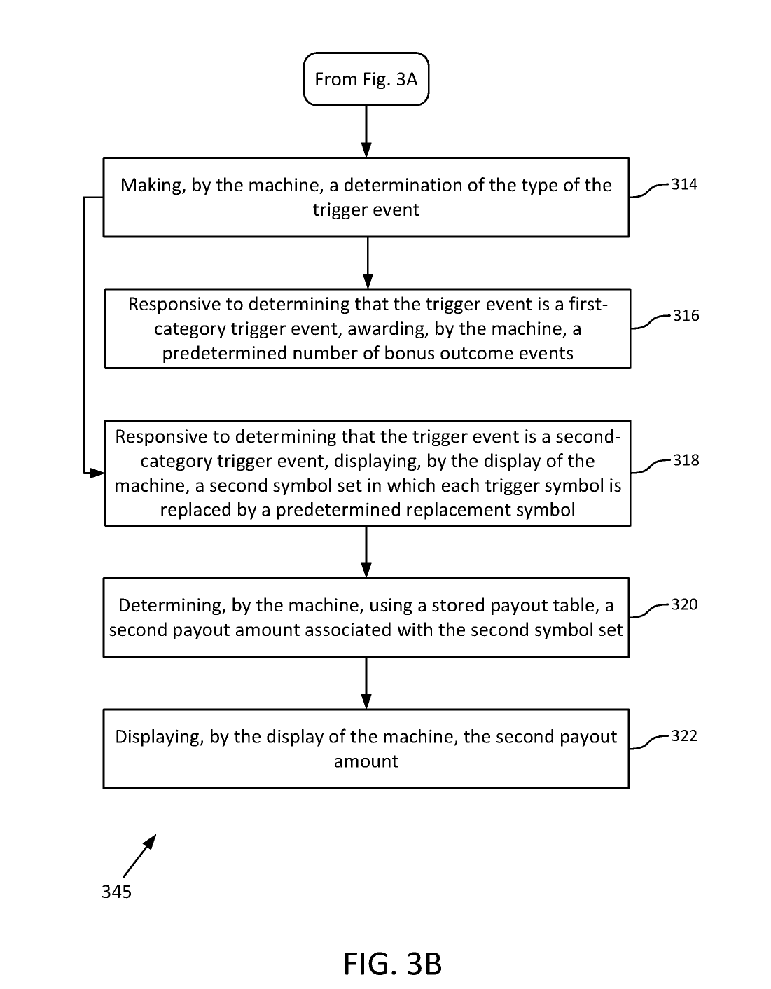

FIG. 3A and FIG. 3B (i.e., FIGS. 3A-3B) depict a flowchart showing a set of operations 345 (or more simply, “the set 345”) that can, for example, be carried out using machine 100. Nonetheless, some or all of these operations may be carried out on server machine 100a and/or client machine 100b.

The operations of the set 345 are shown within blocks labeled with even integers between 300 and 322, inclusive, and can pertain to a method in connection with machine 100. The example method can relate to performing outcome events, such as a wager game. Any other operation(s) described herein as being performed by machine 100 can be performed prior to, while, or after performing any one or more of the operations of the set 345, unless context clearly dictates otherwise. Those other operation(s) can be performed in combination with or separately from any one or more of the operations of the set 345. Any operation described below, or elsewhere in this description, with respect to FIGS. 3A and 3B, can be performed, at least in part, by a processor, such as processor 112 executing software program instructions.

Turning to FIG. 3A, block 300 includes receiving, by machine 100, a wager via the user interface 104. In one example, this may allow a player to enter a wager (e.g., a wager amount) using a keypad of the user interface 104. The wager can be placed on an outcome event, such as, but not limited to, a base outcome event configured as a wager game. The received wager may or may not provide a user of the machine with an opportunity to earn (e.g., win) a payout. Since a received wager does not necessarily provide an opportunity to earn a payout, the received wager can be referred to as a payment. A base outcome event can be carried out after or in response to receiving a payment. Machine 100 can be configured such that a bonus outcome event can be carried out without receiving any additional payment after receiving a payment to carry out a base outcome event that results in an award of a predetermined number of bonus outcome events.

A player using machine 100 may have a corresponding player credit balance from which the entered wager may be deducted in response to the wager being entered or machine 100 receiving a play request from the player. For example, a player may have a player credit balance of 100,000 credits, which may be reduced to 99,750 credits upon the player requesting a play of the game with a wager of 250 credits. Additionally, or alternatively, the wager can be received by entry of a token, coin, or paper bill into the user interface 104 or by sliding or inserting a payment card, such as a credit or debit card, into the user interface 104. Machine 100 can cause display 110 to display wager information such as, but not limited to, a player credit balance on the credit balance indicator 508, possible wager amounts in wager amount indicator 510, and a received wager amount in wager amount indicator 510.

Next, block 302 includes receiving, by machine 100, a play request (e.g., a “spin” request) via the user interface 104. Receiving the play request can include or allow a player to pull a lever or push a button on machine 100 to initiate occurrence of an outcome event or to request a play of the wager game. Receiving the play request can result in the player's credit balance being reduced by an amount of the player's wager or a payment to carry out the outcome event.

Next, block 304 includes determining, by machine 100, a first symbol set to display within the symbol-display-portion 502 of display 110 for the outcome event. Determining the first symbol set can include processor 112 carrying out a random selection, such as a random selection of the first symbol set from a global symbol group.

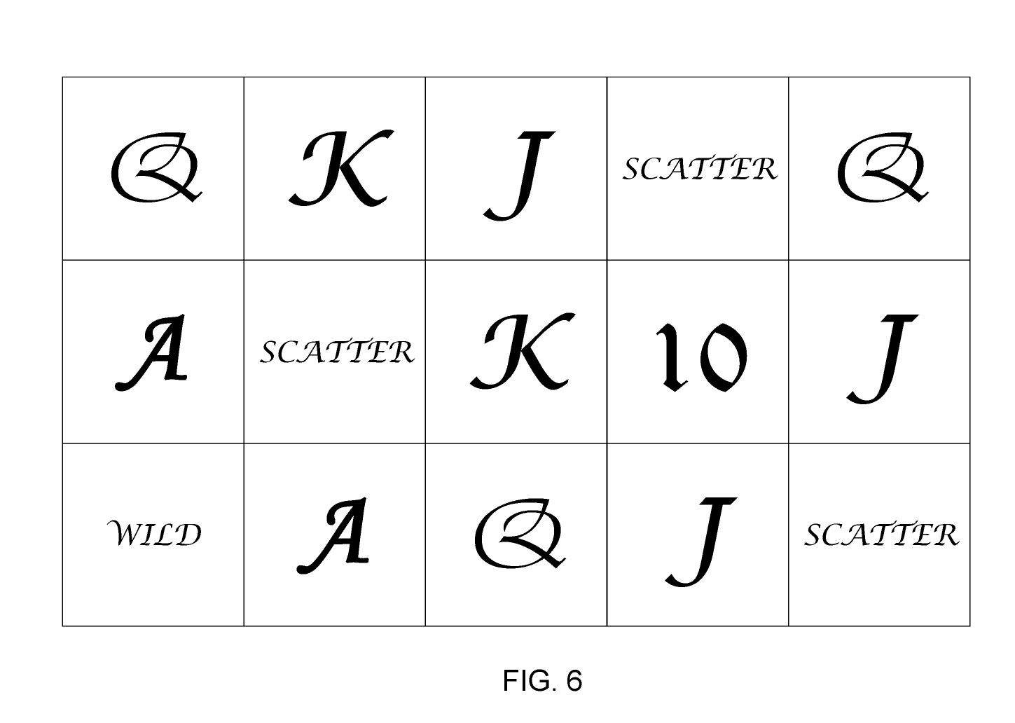

The global symbol group can include multiple symbols, such as a Scatter, a Wild, an Ace, a King, a Queen, a Jack and a Ten that may be used in connection with the outcome event, such as a wager game. The Ace, King, Queen, Jack and Ten symbols can represent symbols found on a standard deck of playing cards. FIG. 6 depicts examples of the aforementioned symbols and examples of other symbols that can be a part of the global symbol group. The global symbol group may be customized with particular symbols as desired.

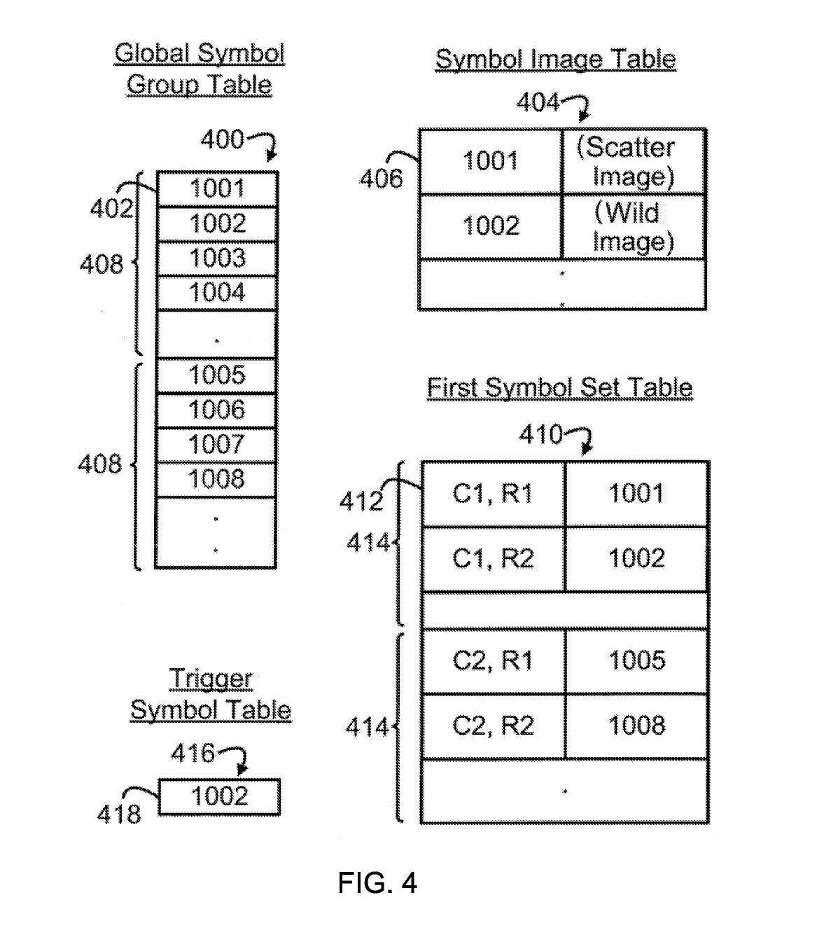

In one example, the global symbol group may be represented as a table (or other data structure) stored in data storage 114. FIG. 4 shows an example global symbol group table 400. The global symbol group table 400 includes multiple records 402, each including an identifier (e.g., 1001, 1002, 1003 1004, etc.) that represents a particular symbol. In one example, the global symbol group, and therefore the global symbol table 400, may be divided into multiple sub-groups 408 as discussed in greater detail below.

The global symbol group table 400 may be used in connection with a symbol image table 404. The symbol image table 404 includes multiple records 406 (shown as distinct rows of table 404), each including an identifier that represents a particular symbol, and a corresponding displayable image. As such, the symbol image table 404 may be used to map an identifier in the global symbol group table 400 to a displayable image.

The selected first symbol set may be represented by a first symbol set table 410. The first symbol set table 410 includes multiple records 412 (shown as distinct rows in table 410), each record including an arrangement position of the symbol, and an identifier that represents the symbol. As such, each symbol in the selected first symbol set may correspond with a respective arrangement position in an arrangement (e.g. both a column number and a row number in a column-and-row arrangement). As an example, C1, R1, shown in the first symbol set table 410, represents a symbol position at column 1 (e.g., a left-most column of a plurality of columns in a symbol-display-portion 502 of display 110) and row 1 (e.g., a top row of a plurality of rows in a symbol-display-portion 502 of display 110). The column identifiers in table 410 (e.g., C1 and C2) can refer to columns in a symbol matrix or reels of a plurality of reels that can be spun.

In one example, machine 100 may select the first symbol set by iterating through each record 412 in the first symbol set table 410, and selecting a symbol identifier from among the symbol identifiers in the global symbol group table 400. In one example the symbol identifiers are numbers and machine 100 uses a random number generator to select such numbers, and therefore to randomly select symbols.

In one example, machine 100 may select each subset in the first symbol set from the corresponding sub-group in the global symbol group. This type of selection may be used when the symbol set represents one or more reels in a reel-type wager game. In this instance, each sub-group includes all the symbols of a given reel, and the selected sub-set includes the symbols of the reel that are “in play”, namely those included in the selected first symbol set.

In one example, the first symbol set may be partially restricted. For instance, the first symbol set may include an instance of a predetermined symbol from the global symbol group, for example, a Wild symbol. In another example, the predetermined symbol may be in a subgroup of global symbol group table 400 distinct from the subgroups from which symbols for the reels are selected.

As noted above, for each symbol in the selected first symbol set, the example embodiments can include machine 100 randomly determining a corresponding arrangement position. As such, in an example where the arrangement is a column-and-row arrangement, machine 100 may randomly determine a column identifier and a row identifier (from a set of potential column identifier and row identifier combinations) for each symbol in the selected first symbol set. In an example where the arrangement has symbol position identifiers (e.g., whole number 1 through 15, inclusive, as described above), machine 100 may randomly select a symbol position identifier for each symbol in the selected first symbol set.

Where the column and row arrangement is used to simulate reels, machine 100 may display the each subset in a corresponding column, such as by superimposing each subset over a virtual reel in a corresponding column. Further, a sub-group 408 may represent an ordering of symbols on a particular reel.

Returning to FIG. 3A, block 306 includes displaying, by the machine 100 on the symbol-display-portion of the display 110, the selected first symbol set.

Next, block 308 includes determining, by machine 100, using a stored payout table (not shown), a first payout amount, where the first payout amount is a function of the selected first symbol set and the received wager. Processor 112 can execute program instructions to determine whether a payout is earned (e.g., won) as a result of each outcome event occurring at machine 100. If a payout is not earned, the payout amount can be zero. If a payout is earned, the payout amount can be a function of the received wager and the symbol set selected for the outcome event (e.g., the first symbol set selected for the first outcome event) or the corresponding arrangements of symbols in the selected first symbol set.

Next, block 310, includes displaying, by display 110 of machine 100, the determined first payout amount. For example, where machine 100 has determined, using the stored payout table, a first payout amount of 500 credits, machine 100 may display on display 110 the determined payout amount of 500 credits. Additionally or alternatively, machine 100 may add the determined payout amount to the player credit balance and display the updated player credit balance. For instance, where the player credit balance was 99,750 credits before the payout amount was determined, machine 100 may add the determined payout amount of 500 credits to the player credit balance so that the updated balance is 100,250 credits. Furthermore, machine 100 can cause display 110 to display a count-up from a first balance amount (e.g., 99,750 credits) to a second balance amount (e.g., 100,250 credits), where the second balance amount equals a sum of the first balance amount and the determined payout amount.

In one example, machine 100 may also physically dispense a corresponding payout (e.g., cash), or otherwise facilitate the payout to the player (by adding funds to an electronic account associated with a gaming card). Additionally or alternatively to determining the payout amount, machine 100 may perform other actions to award the player. For instance, the machine may display an indication of a tangible prize. Other types of awards may be used as well.

FIG. 6 shows an example of a first symbol set 600 from the global symbol group for display during an outcome event. The displayed first symbol set 600 includes (i) three Scatter symbols at arrangement positions C4,R1 and C2,R2 and C5,R3; (ii) a single Wild symbol at arrangement position C1,R3; (iii) a pair of Ace symbols at arrangement positions C1,R2 and C2,R3; (iv) two King symbols at arrangement positions C2,R1 and C3,R2; (v) three Queen symbols at arrangement positions C1,R1 and C5,R1 and C3,R3; (vi) three Jack symbols at arrangement positions C3,R1 and C5,R2 and C4,R3; and (vii) a single Ten symbol at arrangement position C4,R2.

Next, block 312 includes making, by machine 100, a determination that a trigger event occurred. The trigger event can be a randomly occurring event, such as an event that randomly occurs during performance of at least some base outcome events. For example, occurrence of the trigger event can include the presence of at least one trigger symbol in the first symbol set, such as in connection with a previous play of the game (e.g., a base outcome event). Similar to the selection of the first symbol set, in one example, machine 100 may use a random number generator to select the trigger symbol from the global symbol group. In another example, the trigger symbol may be non-randomly selected, such as selecting by a user (e.g. a player, machine designer or casino personnel). In another example, the trigger symbol may be predetermined, for example a Scatter symbol.

Making the determination that the trigger event occurred can take place while machine 100 operates in a first machine state (or more simply, the first state). Machine 100 can be configured such that, while machine 100 is operating in the first state, machine 100 allows the player to play base outcome events in which sets of symbols selected from a global symbol group can be selected by processor 112 and displayed by display 110.

Turning to FIG. 3B, block 314 includes, responsive to machine 100 making the determination (i.e., the determination made at block 312), making, by machine 100, a further determination of the type of the trigger event. For example, a first-category trigger event may include the presence of at least a first quantity of trigger symbols in the first symbol set, and a second category trigger event may include the presence of less than the first quantity of trigger symbols in the first symbol set. Other types of trigger events are possible, including the first-category trigger event and the second-category trigger event not being mutually exclusive.

Next, block 316 includes, responsive to machine 100 determining, at block 314, that the trigger event is a first-category trigger event, awarding, by machine 100, a bonus feature of the game. For example, the bonus feature may be a predetermined number of consecutive plays (e.g., spins and/or patterns of symbols being displayed) of outcome events. The awarded outcome events can be bonus outcome events, such as a game or a wager game. The predetermined number of consecutive outcome events can be conditioned upon a combination of symbols displayed by display 110 as a result of playing a base outcome event. Machine 100 can cause outcome event identifier 504 to identify the bonus outcome event awarded (e.g., a “free spins” bonus) and to cause the outcome event counter 505 to display the predetermined number.

Furthermore, in response to making the determination at block 314, machine 100 can transition from operating in the first state to operating in a second machine state (or more simply, the second state). Machine 100 can be configured such that, while machine 100 is operating in the second state, machine 100 allows the player to play bonus outcome events in which sets of symbols selected from a global symbol group can be selected by processor 112 and displayed by display 110. In accordance with an embodiment in which the symbol-display-portion includes 15 symbol positions, selecting a set of symbols for a bonus outcome event can include selecting 15 symbols.

Machine 100 can be configured to transition from operating in the second state back to operating in the first state. This transition can occur in response to machine 100 determining any of a variety of trigger events, such as, but not limited to, occurrence of all of the awarded predetermined number of consecutive plays of the outcome event, or a player stopping play of machine 100 while one or more of the awarded predetermined number of consecutive plays of the outcome event remain to occur. Machine 100 can be configured to store a number indicating any remaining consecutive plays of the outcome event and to allow a player awarded the consecutive plays to commence playing any remaining consecutive plays of the outcome event at a time after the player stops performing (e.g., playing) the outcome events.

Block 318 includes, responsive to machine 100 determining, at step 314, that the trigger event is a second-category trigger event, displaying, on the display 110, a second symbol set. The displayed second symbol set includes the symbols in the first symbol set other than the trigger symbols, together with a predetermined replacement symbol from the global symbol group in place of each trigger symbol in the first symbol set. In an example where there are multiple trigger symbols, the displayed second symbol set may be identical to the displayed first symbol set, except that each trigger symbol is replaced by a corresponding predetermined replacement symbol. In one example where the trigger symbol is a Scatter symbol, the predetermined replacement symbol may be a Wild symbol. The display 110 may display an indication of the replaceable trigger symbols included in the selected first symbol set. The display 110 may display such an indication by highlighting, shading, hatching or adding a border around the corresponding replaceable trigger symbols, but other indication techniques may also be used.

Next, block 320 includes determining, by machine 100 a second payout amount. In one example, the second payout amount may be determined randomly by machine 100. In another example, the second payout amount may be determined by the machine 100 using a stored payout table (not shown) as a function of the received wager and the symbols in the displayed second symbol set.

Next, block 322 includes displaying, on the display 110, the determined second payout amount. In one example, the machine 100 may also physically dispense a corresponding payout amount (e.g., cash), or otherwise facilitate the payout to the player (by adding funds to an electronic account associated with a gaming card).

In one example, the trigger symbol in the global symbol group may be the Scatter symbol, and the trigger condition may be the presence of one or more such trigger symbols in the displayed first symbol set. The first symbol set of FIG. 6, selected from the global symbol group for display during an outcome event, contains three Scatter symbols, at arrangement positions C4,R1 and C2,R2 and C5,R3, thereby giving rise to the trigger condition.

In the same example, a first-category trigger event may be the presence of three or more trigger symbols in the displayed first symbol set, and a first-category trigger event may result in the award of a bonus feature, such as the award of a predetermined number of bonus outcome events. The three Scatter symbols in the displayed first symbol set constitute a first-category trigger event and will result in the award of the predetermined number of bonus outcome events such as, for example, 10 “free spins.”

FIG. 7 shows an example of another first symbol set 700 selected from the global symbol group for display during a different base outcome event. The displayed first symbol set 700 includes two trigger symbols (i.e., Scatter symbols) at arrangement positions C1,R3 and C3,R2. The displayed first symbol set 700 of FIG. 7, while fulfilling a trigger condition due to the presence of the two Scatter symbols, does not give rise to a first-category trigger condition for which three or more Scatter symbols are required. Thus, unlike the first symbol set 600 of FIG. 6, symbol set 700 does not trigger an award of the predetermined number of bonus outcome events.

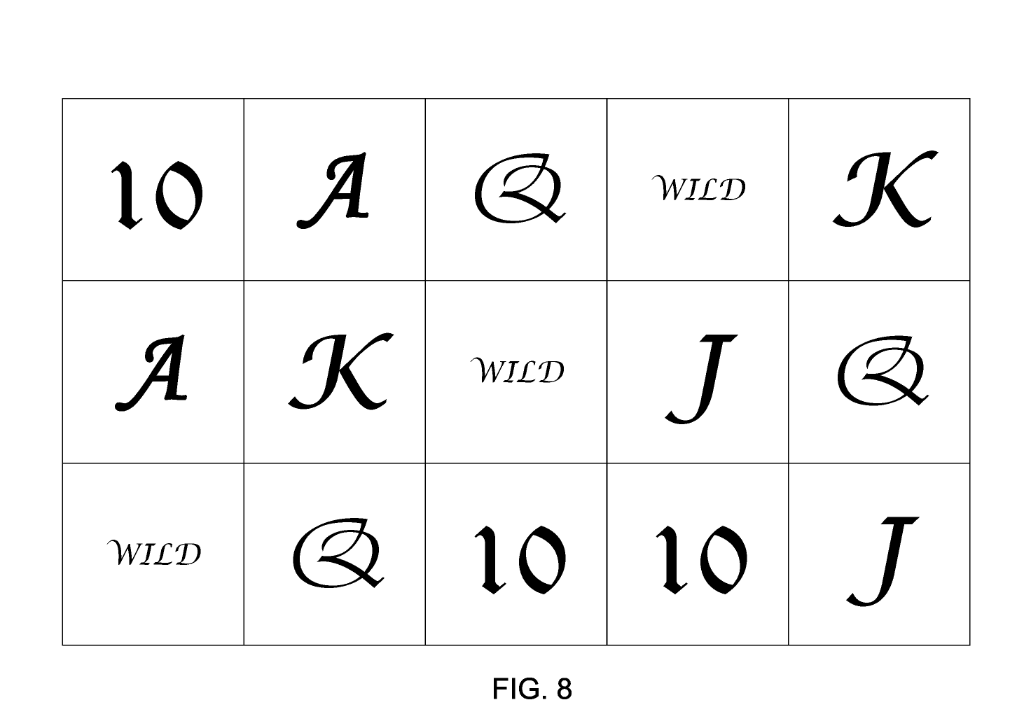

Turning to FIG. 8, machine 100 may directly replace each of the Scatter symbols in the first symbol set with the predetermined replacement symbol in the global symbol group, i.e., the Wild symbols. As illustrated in FIG. 8, the Scatter symbols at arrangement positions C1,R3 and C3,R2 have each been replaced by a Wild symbol. The symbol set 800 of FIG. 8 constitutes the second symbol set as described above in relation to block 318, which includes the non-trigger symbols in the first symbol set 700 and in which each trigger symbol of the first symbol set has been replaced by a predetermined replacement symbol.

Machine 100 can cause symbol-display segments to spin, and to cause spinning symbol-display-segments to stop spinning. The spinning and stopping of the spinning symbol-display segments can be carried out for each outcome event. In accordance with the embodiments in which the symbol-display-portion 502 includes columns or reels that spin from top to bottom or bottom to top, spinning the reels can include starting the spinning from a left-most column or reel to a right-most column or reel. Stopping the reels can occur using a similar sequence. Other sequences of spinning and stopping the spinning can be used. Moreover, the spinning or stopping of spinning of two or more columns or reels could occur simultaneously.

Notably, the operations of replacing, reordering, adding, and/or removing symbols from a reel of a reel-based game (e.g., the operations of blocks 318, 920, and 1020 as just some possible examples), necessitate computer implementation. In a mechanical reel-based game, the symbols appearing on each reel are fixed and cannot be changed mid-game. In contrast, the computer implementation herein allows the number of symbols per reel to be changed, as well as the symbols appearing on each reel to be replaced and/or re-ordered. These changes can occur mid-game, for example between spins of the reels. Consequently, these features of the disclosure herein would not exist but for computer technology.

Further, these features are an improvement to reel-based gaming technology. Since the symbols appearing on each reel are fixed and cannot be changed mid-game in mechanical reel-based games, the operations of replacing, reordering, adding, and/or removing symbols from a reel could not appear in such games. Due to this technological limitation, players may become disinterested in these basic reel-based games. Computer implementation, however, facilitates the integration of these features into reel-based games, resulting in game dynamics that would otherwise be unavailable. Consequently, the disclosure herein is a technological improvement to reel-based games.

### IV. Additional Example Operations

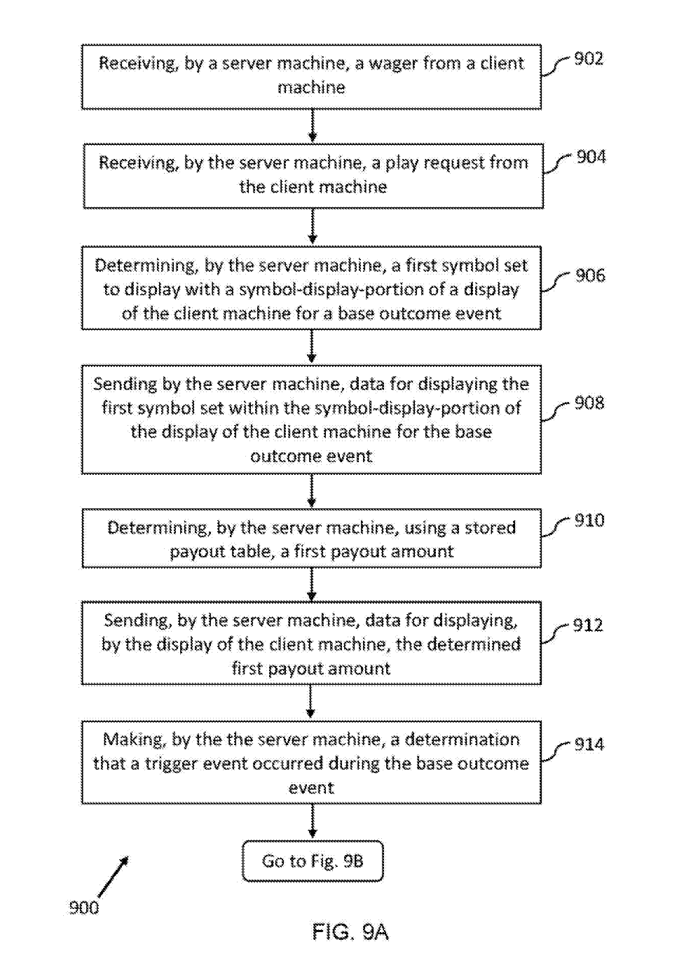

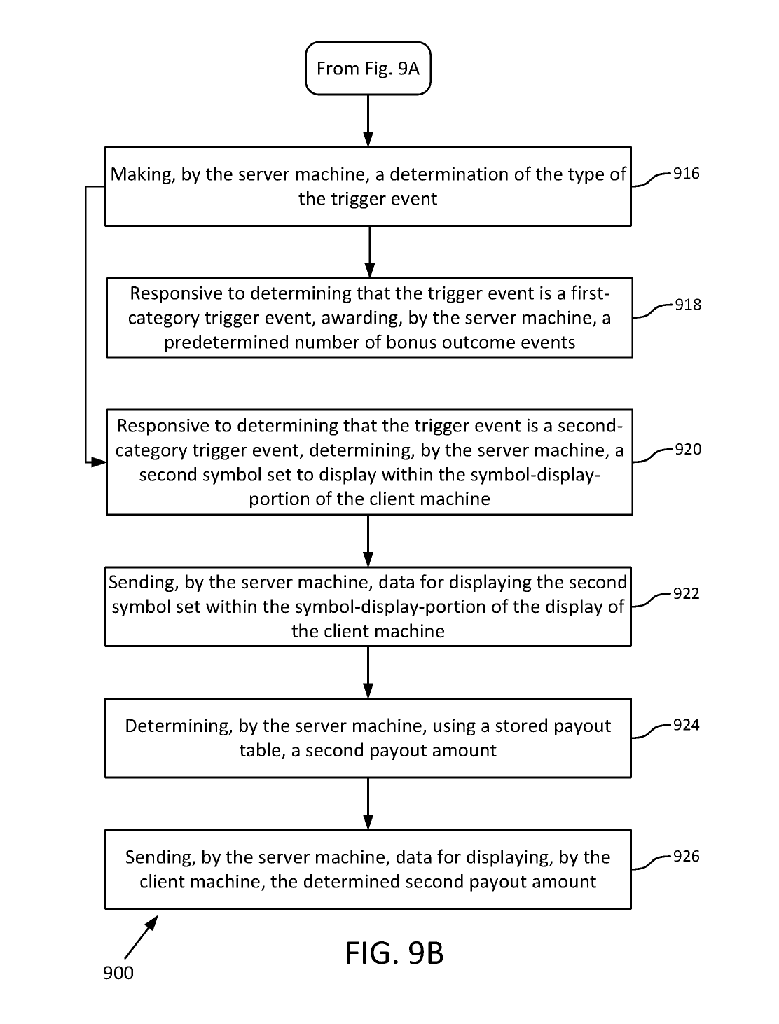

FIGS. 9A-9B depict a flowchart showing a set of operations 900 (or more simply, “the set 900”) that can, for example, be carried out using server machine 100a. Note that several of the operations described in connection with FIG. 9A-9B parallel operations described in connection with FIG. 3A-3B. As such, variations of the operations described in connection with FIG. 3A-3B are likewise applicable to the operations described in connection with FIG. 9A-9B. However, for the sake of brevity, these variations are not repeated. The server machine 100a, in performing the set 900, can perform the operations described above with respect to machine 100.

Turning to FIG. 9A, block 902 includes receiving, by the server machine 100a, a wager from the client machine 100b.

Next, block 904 includes receiving, by the server machine 100a, a play request from the client machine 100b.

Next, block 906 includes determining, by the server machine 100a, a first symbol set to display within the symbol-display-portion of the display 110b of the client machine 100b for a base outcome event.

Next, block 908 includes sending, by the server machine 100a, data for displaying, by the display 110b of the client machine 100b, the first symbol set within the symbol-display-portion of the display.

Next, block 910 includes determining, by the server machine 100a using a stored payout table, a first payout amount associated with the first symbol set.

Next, block 912 includes sending, by the server machine 100a, data for displaying, by the display 110b of the client machine 100b, the determined first payout amount.

Next, block 914 includes making, by the server machine 100a, a determination that a trigger event occurred during the base outcome event.

Turning to FIG. 9B, block 916 includes making, by the server machine 100a, a determination of the type of the trigger event.

Next, block 918 includes, responsive to determining that the trigger event is a first-category trigger event, awarding, by the server machine 100a, a predetermined number of consecutive bonus outcome events.

Block 920 includes, responsive to determining that the trigger event is a second-category trigger event, determining, by the server machine, a second symbol set. The second symbol set may be displayed within the symbol-display-portion of the display 110b of the client machine, with each trigger symbol in the first symbol set replaced by a predetermined replacement symbol.

Next, block 922 includes sending, by the server machine 100a, data for displaying, by the display 110b of the client machine 100b, the second symbol set within the symbol-display-portion of the display.

Next, block 924 includes determining, by the server machine 100a, using a stored payout table, a second payout amount associated with the second symbol set.

Next, block 926 includes sending, by the server machine 100a, data for displaying, by the display device 110b of the client machine 100b, the determined second payout amount.

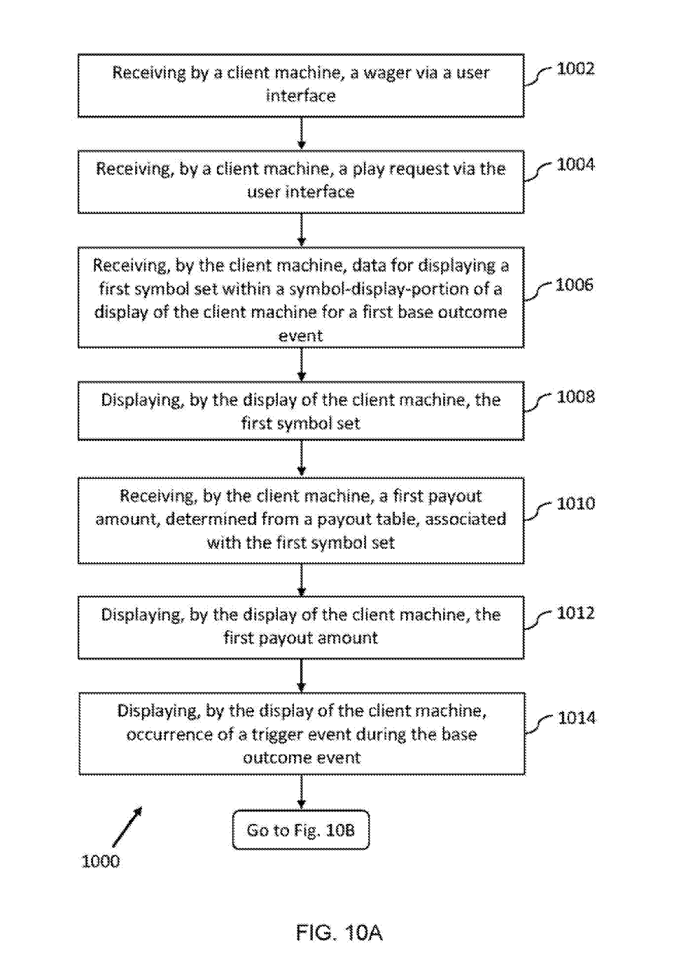

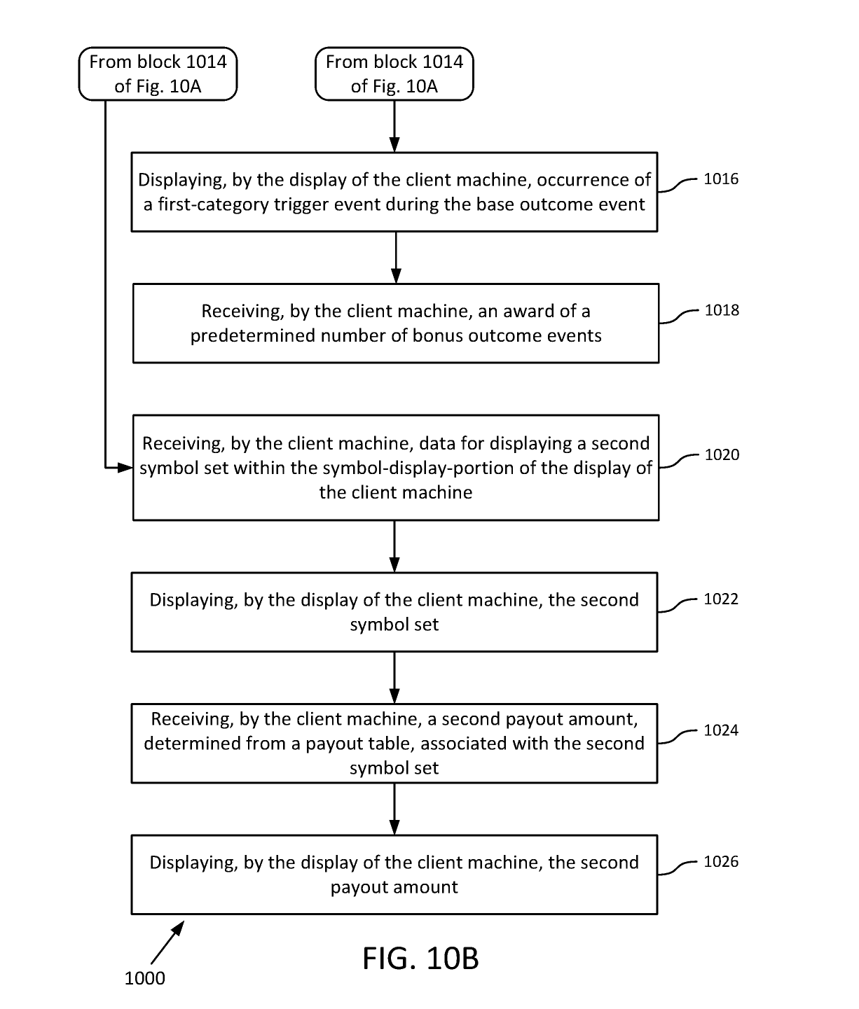

FIGS. 10A-10B depict a flowchart showing a set of operations 1000 (or more simply, “the set 1000”) that can, for example, be carried out using client machine 100b. Note that several of the operations described in connection with FIGS. 10A-10B parallel operations described in connection with FIGS. 3A-3B and FIGS. 9A-9B. As such, variations of the operations described in connection with FIGS. 3A-3B and FIGS. 9A-9B are likewise applicable to the operations described in connection with FIGS. 10A-10B. However, for the sake of brevity, these variations are not repeated. The client machine 100b, in performing the set 1000, can perform the operations described above with respect to machine 100.

Turning to FIG. 10A, block 1002 includes receiving, by the client machine 100b, a wager via the user interface 104b. Client machine 100b can transmit the received wager or data indicative thereof over the communication network 116 to server machine 100a.

Next, block 1004 includes receiving, by the client machine 100b, a play request via the user interface 104b. Client machine 100b can transmit the received play request or data indicative thereof over the communication network 116 to server machine 100a.

Next, block 1006 includes receiving, by the client machine 100b, data for displaying a first symbol set within the symbol-display portion of the display 110b for a first base outcome event.

Next, block 1008 includes displaying, by the display 100b of the client machine 100b, the first symbol set.

Next, block 1010 includes receiving, by the client machine 100b, a first payout amount, determined from a payout table, associated with the first symbol set.

Next, block 1012 includes displaying, by the display 110b of the client machine 100b, the determined first payout amount.

Next, block 1014 includes displaying, by the display 110b of the client machine 100b, occurrence of a trigger event during the base outcome event.

Turning to FIG. 10B, block 1016 includes displaying by the display 110b of the client machine, occurrence of a first-category trigger event during the base outcome event.

Next, block 1018 includes receiving, by the client machine 100b, an award of a predetermined number of consecutive bonus outcome events.

Block 1020 includes receiving, by the client machine 100b, data for displaying a second symbol set within the symbol-display-portion, in which each trigger symbol in the first symbol set is replaced by a predetermined replacement symbol.

Next, block 1022 includes displaying, by the display 100b of the client machine 100b, the second symbol set.

Next, block 1024 includes receiving, by the client machine 100b, a second payout amount, determined from a payout table, associated with the second symbol set.

Next, block 1026 includes displaying, by the display 110b of the client machine 100b, the determined second payout amount.

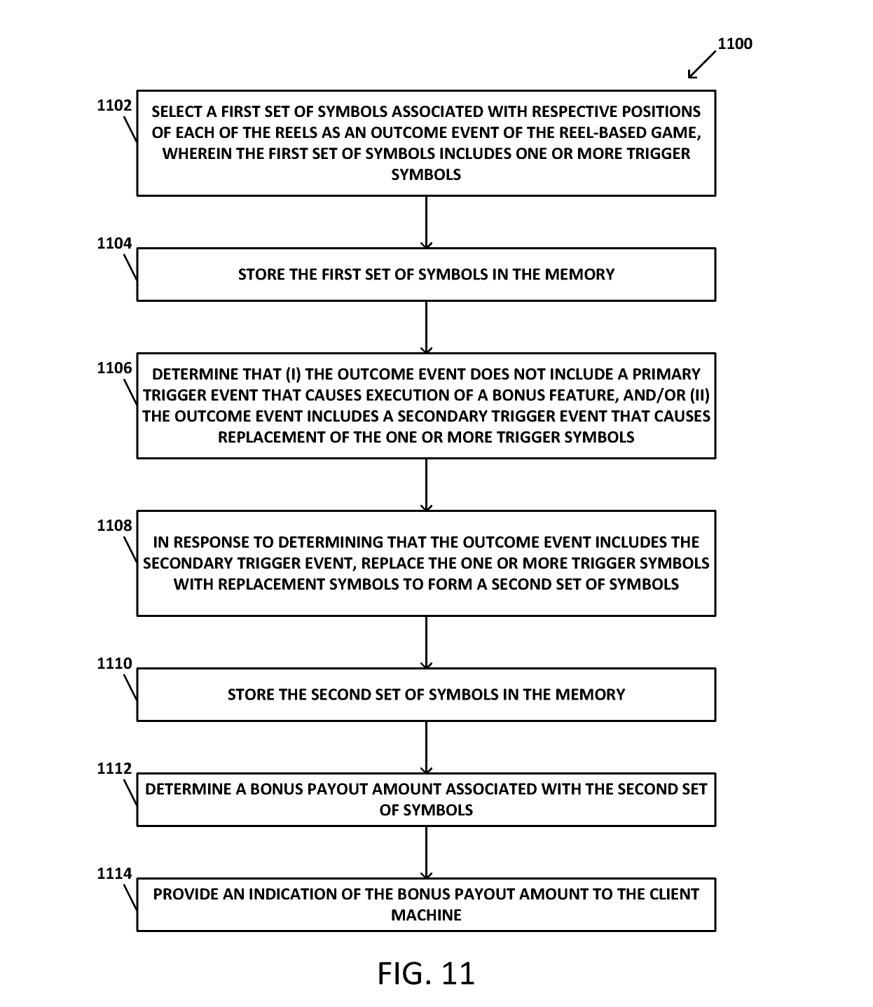

FIG. 11 depicts a flowchart showing a set of operations 1100 (or more simply, “the set 1100”) that can, for example, be carried out using server machine 100a and/or client machine 100b. To the extent that a client machine carries out any of the set 1100, these operations may also include displaying various types of information, such as symbol sets, payout amounts, and so on. Note that several of the operations described in connection with FIG. 11 parallel operations described in connection with FIGS. 3A-3B, FIGS. 9A-9B, and FIGS. 10A-10B. As such, variations of the operations described in connection with FIGS. 3A-3B, FIGS. 9A-9B, and FIGS. 10A-10B are likewise applicable to the operations described in connection with FIG. 11.

Turning to FIG. 11, block 1102 includes selecting a first set of symbols associated with respective positions of each of the reels as an outcome event of the reel-based game. The first set of symbols includes one or more trigger symbols.

Next, block 1104 includes storing the first set of symbols in the memory.

Next, block 1106 includes determining that (i) the outcome event does not include a primary trigger event that causes execution of a bonus feature, and/or (ii) the outcome event includes a secondary trigger event that causes replacement of the one or more trigger symbols.

Next, block 1108 includes, possibly in response to determining that the outcome event includes the secondary trigger event, replacing the one or more trigger symbols with replacement symbols to form a second set of symbols.

Next, block 1110 includes storing the second set of symbols in the memory.

Next, block 1112 includes determining a bonus payout amount associated with the second set of symbols.

Next, block 1114 includes providing an indication of the bonus payout amount to the client machine.

The respective pluralities of symbols for the reels may be arranged in respective cyclical sequences of symbols. Selecting the first set of symbols may involve, for each reel, randomly selecting a respective reel position such that a respective subsequence of the symbols thereon are in the first set of symbols.

Selecting the first set of symbols may involve simulating spins of the plurality of reels.

The primary trigger event may involve the first set of symbols including at least n trigger symbols, and the secondary trigger event may involve the first set of symbols including less than n trigger symbols. The secondary trigger event may involve the first set of symbols including n-1 trigger symbols. In some cases, n is 3, but n may take on other values instead.

The bonus feature may involve a bonus game. The bonus feature may also involve a predetermined number of bonus outcome events.

The trigger symbols may be Scatter symbols and the replacement symbols may be Wild symbols. The bonus payout amount may be based on a number of Wild symbols in the second set of symbols.

The reel-based game may have five reels and each of the five reels may contribute three symbols to the first set of symbols.

The embodiment of FIG. 11 may also involve determining a payout amount associated with the first set of symbols, and providing an indication of the payout amount to the client machine.

The client machine may be associated with a credit account. The credit account may be debited to play the reel-based game, and credited in response to the primary triggering event and/or the secondary triggering event.

The one or more processors may simultaneously execute reel-based games in real time on behalf of at least 30 client machines, where each of the at least 30 client machines communicates with the one or more processors by way of a wide-area packet-switched network. In some cases, the one or more processors may simultaneously execute reel-based games in real time on behalf of more or fewer than 30 client machines. For instance, this simultaneous execution may involve 10, 20, 50, 100, or 1000 client machines, or another extent of client machines.

Particularly, simultaneous execution of such a large number of reel-based games in real time necessitates computer implementation. When taking part in an online game, such as the reel-based games disclosed herein, players expect results of reel spin or symbol replacement operations to be displayed on their respective client machines in an expeditious fashion (e.g., in real time, such as a few seconds at most per either of these operations). Failure to do so may result in players becoming disinterested in the game. Consequently, the embodiments that include this simultaneous execution a large number of reel-based games in real time would not exist but for computer implementation thereof.

The client machine may include the one or more processors and the memory.

The embodiment of FIG. 11 may also involve, (i) after providing the indication of the bonus payout amount to the client machine, selecting a third set of symbols associated with respective positions of each of the reels as a second outcome event of the reel-based game, where the third set of symbols includes one or more trigger symbols, (ii) storing the third set of symbols in the memory, (iii) determining that the second outcome event includes a primary trigger event that causes execution of a bonus feature, and (iv) possibly in response to determining that the outcome event includes the primary trigger event, executing the bonus feature on behalf of the client machine.

### V. Conclusion

While one or more disclosed operations have been described as being performed by certain entities (e.g., machine 100, server machine 100a, or client machine 100b), one or more of the operations may be performed by any entity, including but not limited to those described herein. As such, while this disclosure includes examples in which the server machine 100a performs select operations and sends data to the client machine 100b, such that the client machine 100b may perform complementing operations and receive the data, variations may to those operations may be made while adhering to the general server-client dichotomy and the scope of the disclosed machines and methods.

For example, rather than the server machine 100a sending select data (e.g., a symbol set) to the client machine 100b, such that the client machine may generate and display appropriate images, the server machine 100a may itself generate the images and send them to the client machine 100b for display. Indeed, it will be appreciated by one of ordinary skill in the art that the “break point” between the server machine's operations and the client machine's operations may be varied.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

What is claimed is:

1. A computer-implemented method for symbol replacement in a reel-based game, wherein the reel-based game is executed on behalf of a client machine, wherein the reel-based game involves spinning a plurality of reels to determine outcome events, and wherein a memory stores respective pluralities of symbols for the reels, the method comprising:
selecting, by one or more processors, a first set of symbols associated with respective positions of each of the reels as an outcome event of the reel-based game, wherein the first set of symbols includes one or more trigger symbols;
storing, by the one or more processors, the first set of symbols in the memory;
determining, by the one or more processors, that (i) the outcome event does not include a primary trigger event that causes execution of a bonus feature, and (ii) the outcome event includes a secondary trigger event that causes replacement of the one or more trigger symbols;
in response to determining that the outcome event includes the secondary trigger event, replacing, by the one or more processors, the one or more trigger symbols with replacement symbols to form a second set of symbols;
storing, by the one or more processors, the second set of symbols in the memory;
determining, by the one or more processors, a bonus payout amount associated with the second set of symbols; and
providing, by the one or more processors, an indication of the bonus payout amount to the client machine.

2. The method of claim 1, wherein the respective pluralities of symbols for the reels are arranged in respective cyclical sequences of symbols, and wherein selecting the first set of symbols comprises:
for each reel, randomly selecting a respective reel position such that a respective subsequence of the symbols thereon are in the first set of symbols.

3. The method of claim 1, wherein selecting the first set of symbols comprises simulating spins of the plurality of reels.

4. The method of claim 1, wherein the primary trigger event comprises the first set of symbols including at least n trigger symbols, and wherein the secondary trigger event comprises the first set of symbols including less than n trigger symbols.

5. The method of claim 4, wherein the secondary trigger event comprises the first set of symbols including n-1 trigger symbols.

6. The method of claim 4, wherein n is 3.

7. The method of claim 1, wherein the bonus feature comprises a bonus game.

8. The method of claim 1, wherein the bonus feature comprises a predetermined number of bonus outcome events.

9. The method of claim 1, wherein the trigger symbols are Scatter symbols and the replacement symbols are Wild symbols.

10. The method of claim 9, wherein the bonus payout amount is based on a number of Wild symbols in the second set of symbols.

11. The method of claim 1, wherein the reel-based game has five reels and each of the five reels contributes three symbols to the first set of symbols.

12. The method of claim 1, further comprising:
determining, by the one or more processors, a payout amount associated with the first set of symbols; and
providing, by the one or more processors, an indication of the payout amount to the client machine.

13. The method of claim 1, wherein the client machine is associated with a credit account, and wherein the credit account is debited to play the reel-based game, and credited in response to the primary triggering event and the secondary triggering event.

14. The method of claim 1, wherein the client machine comprises the one or more processors and the memory.

15. The method of claim 1, further comprising:
after providing the indication of the bonus payout amount to the client machine, selecting a third set of symbols associated with respective positions of each of the reels as a second outcome event of the reel-based game, wherein the third set of symbols includes one or more trigger symbols;
storing the third set of symbols in the memory;
determining that the second outcome event includes a primary trigger event that causes execution of a bonus feature; and
in response to determining that the outcome event includes the primary trigger event, executing the bonus feature on behalf of the client machine.

16. The method of claim 1, wherein selecting the first set of symbols comprises transmitting a representation of the first set of symbols to the client machine, wherein replacing the one or more trigger symbols with replacement symbols to form a second set of symbols comprises transmitting a representation of the second set of symbols to the client machine, and wherein providing the indication of the bonus payout amount to the client machine comprises transmitting a representation the bonus payout amount to the client machine.

17. The method of claim 16, wherein the client machine includes a display device, wherein each of transmitting the representation of the first set of symbols to the client machine, transmitting the representation of the second set of symbols to the client machine, and transmitting the representation the bonus payout amount to the client machine causes the client machine to display, by way of the display device, the respective transmitted representation.

18. The method of claim 1, wherein the client machine includes an input mechanism, wherein selection of the first set of symbols is triggered by way of the input mechanism.

19. An article of manufacture including a non-transitory computer-readable medium, having stored thereon program instructions that, upon execution by a gaming machine, cause the gaming machine to perform operations comprising:
selecting a first set of symbols associated with respective positions of each of the reels as an outcome event of the reel-based game, wherein the first set of symbols includes one or more trigger symbols;
determining that (i) the outcome event does not include a primary trigger event that causes execution of a bonus feature, and (ii) the outcome event includes a secondary trigger event that causes replacement of the one or more trigger symbols;
in response to determining that the outcome event includes the secondary trigger event, replacing the one or more trigger symbols with replacement symbols to form a second set of symbols;
determining a bonus payout amount associated with the second set of symbols; and
providing an indication of the bonus payout amount to the client machine.

20. A gaming system configured for symbol replacement in a reel-based game, wherein the reel-based game is executed on behalf of a client machine, wherein the reel-based game involves spinning a plurality of reels to determine outcome events, the gaming system comprising:
a plurality of gaming devices each including at least one display device and a plurality of input devices including (i) an acceptor of a physical item associated with a monetary value, (ii) a validator configured to identify the physical item, and (iii) a cash-out button actuatable to cause an initiation of a payout associated with a credit account;
one or more gaming device processors; and
one or more gaming device memory devices storing (i) respective pluralities of symbols for the reels and (ii) a plurality of gaming device instructions executable by the one or more gaming device processors to perform operations comprising:
selecting a first set of symbols associated with respective positions of each of the reels as an outcome event of the reel-based game, wherein the first set of symbols includes one or more trigger symbols;
storing the first set of symbols in the one or more gaming device memory devices;
determining that (i) the outcome event does not include a primary trigger event that causes execution of a bonus feature, and (ii) the outcome event includes a secondary trigger event that causes replacement of the one or more trigger symbols;
in response to determining that the outcome event includes the secondary trigger event, replacing the one or more trigger symbols with replacement symbols to form a second set of symbols;
storing the second set of symbols in the one or more gaming device memory devices;
determining a bonus payout amount associated with the second set of symbols; and
providing, on a display device of the at least one display device, an indication of the bonus payout amount.
